(19) United States
(12) Patent Application Publication
(10) Pub. No.: US 2020/0230975 A1
(43) Pub. Date: Jul. 23, 2020

(54) SECURE ITEM IDENTIFICATION BASED ON PHYSICAL LABEL PROPERTIES

(71) Applicant: INEXTO SA, Lausanne (CH)

(72) Inventors: Erwan Fradet, Grandvaux (CH); Patrick Chanez, Cheyres (CH); Philippe Chatelain, Charvornay (CH)

(21) Appl. No.: 16/066,196

(22) PCT Filed: Dec. 23, 2016
(86) PCT No.: PCT/EP2016/082608

§ 371 Date: Jun. 26, 2018

Related U.S. Application Data
(60) Provisional application No. 62/273,437, filed on Dec. 31, 2015.

(51) Int. Cl. B41J 3/407; G06Q 30/00; G06Q 10/08

(52) U.S. Cl. CPC B41J 3/4075; G06Q 10/087; G06Q 30/0185

(57) ABSTRACT

The present invention relates to methods, network devices, and machine-readable media for an integrated environment for generating a secure item identification code associated with or based on a measured physical property of an item, such as a label or a stamp.

This application claims the benefit of U.S. Provisional Application Ser. No. 62/273,437, filed Dec. 31, 2015, the contents which are herein incorporated by reference in its entirety.

The present invention relates to methods, network devices, and machine-readable media for an integrated environment for generating a secure item identification code associated with or based on a measured physical property of an item, such as a label or a stamp.

A system is needed to allow tracking and tracing of products that are manufactured and authenticated. In particular, this is true for articles that are heavily taxed, e.g. excise taxed, where an external body, for example a government, needs to keep, independent of the manufacturer, track of the number of goods that have been produced by a product manufacturer. At the same time, the government may be interested to be able to identify genuine and counterfeit products based on existing technologies.

The following embodiments of the invention are exemplary and are not intended to be limiting of the scope of the invention. While one or more embodiments of the present invention have been described, various alterations, additions, permutations and equivalents thereof are included within the scope of the invention. In the following description of embodiments, reference is made to the accompanying drawings that form a part hereof, which show by way of illustration specific embodiments of the claimed subject matter. It is to be understood that other embodiments may be used and that changes or alterations, such as structural changes, may be made. Such embodiments, changes or alterations are not necessarily departures from the scope with respect to the intended claimed subject matter. While the steps below may be presented in a certain order, in some cases the ordering may be changed so that certain inputs are provided at different times or in a different order without changing the function of the systems and methods described. Various computations that are described below, such as those within the code initialization, generation, and authentication procedures, need not be performed in the order disclosed, and other embodiments using alternative orderings of the computations could be readily implemented. In addition to being reordered, the computations could also be decomposed into sub-computations with the same results.

Embodiments of the invention will now be described, by way of example, with reference to the accompanying drawings, in which:

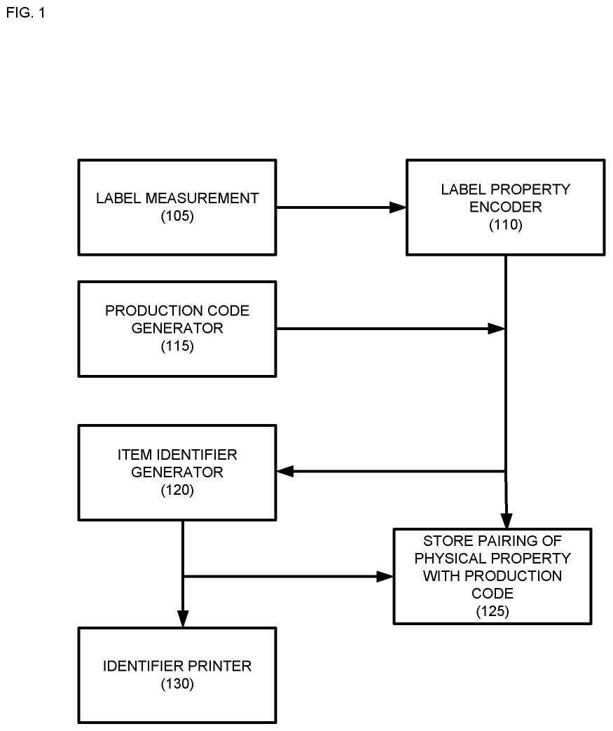

FIG. 1 illustrates an example system for item identifier generation according to one embodiment.

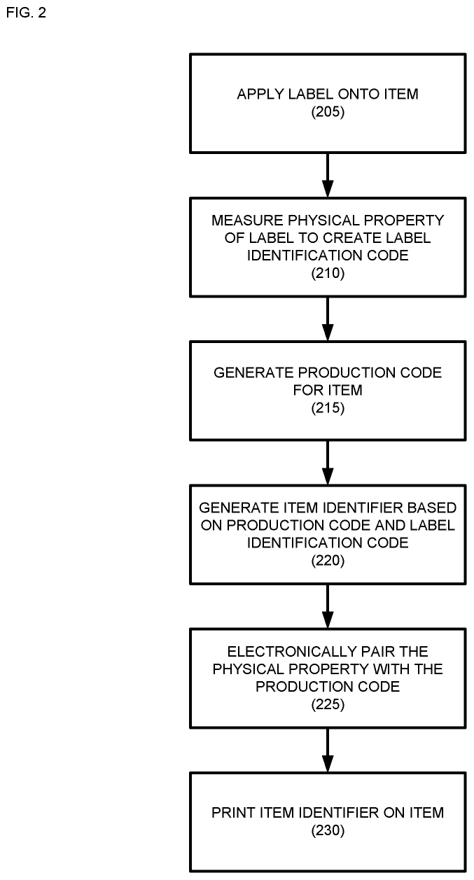

FIG. 2 illustrates an example method for pairing label features and production codes according to one embodiment.

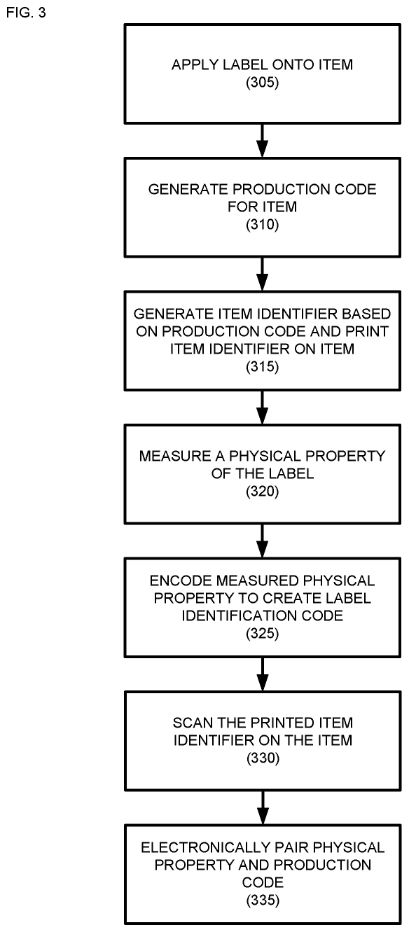

FIG. 3 illustrates an example method for pairing label features and production codes according to another embodiment.

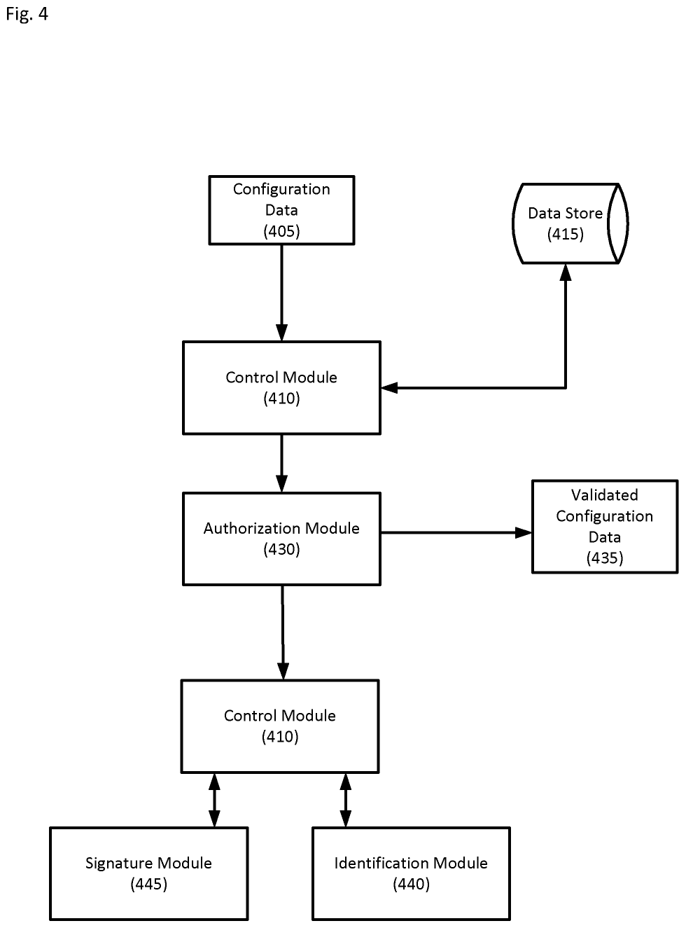

FIG. 4 illustrates an example method for code initialization for use with secure item identifier generation.

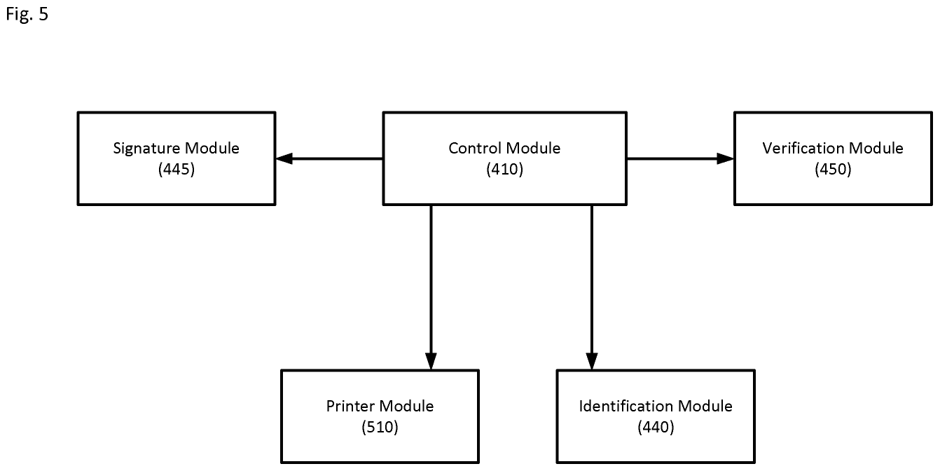

FIG. 5 illustrates an example method for code generation for use with secure item identifier generation.

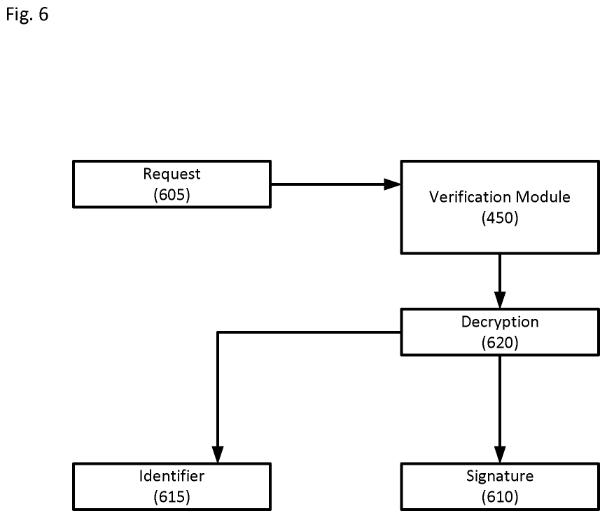

FIG. 6 illustrates an example method for code authorization for use with secure item identifier generation.

### Overview of System Processes

A label is used to generate an identifier of the label, for example by a high-resolution scan of the entire label or of a specific area of the label. This scan is then used to generate a label identification code. As an example, the identification code could be based on the fiber structure of the label, which is inherently random in some materials. The label identification code is then linked to or combined with a product identification code to securely associate an item bearing the identification code with the label. As used herein, the codes and identifiers can be numeric, alphabetic, or graphic characters or elements, or any combination of numeric, alphabetic, or graphic characters or elements.

The systems and methods described herein can be implemented in software or hardware or any combination thereof. The systems and methods described herein can be implemented using one or more computing devices which may or may not be physically or logically separate from each other. One example embodiment is illustrated in FIG. 1. Label measurement module (105) can be in communication with label property encoder module (110) to transmit label measurement data.

Production code generator module (115) can be in communication with item identifier generator module (120) which can generate an item identifier based on the input from production code generator module (115) and label property encoder module (110). The output of production code generator module (115) and label property encoder module (110) can be associated and stored in electronic data store module (125). The generated item identifier from item identifier generator module (120) can be printed into item by identifier printer module (130).

### Physical Property Measurement

A physical property, or feature, of a label on an item, such as an item in commerce, can be measured. As a non-limiting example, the physical properties measured could be properties of the fibers of a label. As a further non-limiting example, the label could be a stamp, which could be fabricated from paper materials, alone or in combination with other materials. In some embodiments, the label may be a stamp, which may be indicia that are stamped onto a support with a stamp. In some embodiments, the label may be ink or materials deposited directly on item packaging. As used herein, the label could be any arbitrary feature of item packaging that has been designated for the purpose of being an identifying aspect, attribute, or area of the packaging, including original packaging or materials that are attached to original packaging.

The physical properties of the features of the label may include any properties which are measurable. In particular, the properties may be those features having predetermined macroscopic characteristics as well as random, non-reproducible microscopic characteristics, wherein the microscopic and macroscopic characteristics can be imageable using a predetermined imaging technology. As non-limiting examples, some of the characteristics that could be measured could be any of average fiber length, fiber orientation, contrast between elements, two dimensional location of the fibers (e.g., the X/Y position of the ten most visible fibers, or density of fibers of a certain visibility, etc.) Some fibers could be differently colored and the detection could rely on the colorings (in some embodiments, including features that become only visible under UV light). Measured characteristics could also be a distinguishing characteristic (a “fingerprint”) of a printer that applies ink to a label. The measured property could be reflection from metal or plastic particles or chips in the label. In some embodiments, the label imaged may use layered security printed on the label that combine overt and covert counterfeit-resistant features in the printed design.

The predetermined, reproducible macroscopic characteristics of the features may comprise a size or a shape of an overt feature. The shape of the overt feature may comprise a code, a symbol, a graphic, or an alpha-numeric character, wherein the size of the overt feature renders the shape discernible to a naked eye, or wherein the size of the overt feature renders the shape discernible only under magnification. The random, non-reproducible microscopic characteristics of the overt feature may comprise a predetermined resolution, coarseness, surface roughness, or other property enabling reproducible imaging of the random, non-reproducible microscopic characteristics using the predetermined imaging technology. The non-reproducible microscopic characteristics may be reproducibly imageable using the predetermined imaging technology under magnification. As non-limiting examples, overt features can include variable optical effects in different lighting conditions, serialization based on unique serial numbers in visible or ultraviolet fluorescing print, and barcodes.

As a non-limiting example, the fiber structure of a paper or fabric label could also be used as a covert characteristic, the characteristic further including other, visible or overt information on the label, such as a country code, the price of the product, the number of the products in a package, a codified producer, or brand. Label features could be derived from inherent randomness in the physical structure of the label, a watermark, or ink on or in the label. For example, label printing techniques can be used that allow random or pseudorandom application of color onto or in the label.

Covert features could include a laser readable image that can only be seen by interrogating the label with a customized laser reading device, hoxel shapes micro-positioned in a hologram, micro text (e.g., between 0.1 and 0.2 mm high and not visible to the naked eye), letters in contrasting or diffractive text, micro data matrices such as a 250 mm barcode, and micro images (e.g., 150 micron elements rendered via e-beam). Additional or alternative covert security features could be, e.g., security tags that could be intermixed with the pulp in paper label embodiments.

Detailed imaging of the label may be performed using a microscope that has a system of lenses (objectives and eyepiece) so that different magnifications (e.g., 20× to 1000×) can be achieved. As non-limiting examples, surface and microstructure analysis can be performed by high-resolution photography, scanning electron microscopy, atomic force microscopy, transmission electron microscopy, scanning probe microscopy, optical microscopy analysis, auger electron spectroscopy, nano-materials analysis, x-ray diffraction, cryo-electron microscopy, and vertical scanning, phase shifting interferometry. Other systems and methods capable of arbitrarily higher resolutions and magnifications can also be utilized for highly detailed microstructural imaging of features of the label.

A feature reading apparatus can include any components or aspects as are necessary or desirable according to the technology employed to produce the feature in order to read, measure, image, or otherwise determine the properties of the feature so created, and for example may include any sensors suitable to measure or determine the properties. The feature reading apparatus may include or cooperate with other aspects to facilitate measurement or imaging of the feature, and may include in some embodiments a holder which may incorporate a source of controlled illumination, a special lens and a locator which permits the label to be positioned in a predetermined position, within predetermined tolerances. The feature reading apparatus may further include or cooperate with imaging sensors, such as a camera, which may constitute an imaging system. The system may include processing apparatus connected to or otherwise cooperating with the feature reading apparatus or imaging system to generate and obtain the measurement or image of the feature.

The processing apparatus, having received the collected image from the camera or other feature imaging or detecting apparatus, may be provided with software or otherwise configured to process the image as desired. For example, the processing apparatus may be configured to decompose the image into elements, to classify elements therein, to analyze the elements according to predefined algorithms, and characterize the features of the label.

The image or other feature data, such as topological mapping, represents a physical property of the label. This physical property data collected from the label can be electronically stored on a data storage device. The physical property data can be stored in any practical file format, such as image files, database entries, or raw data.

### Physical Property Encoding

The physical property data can be further processed to generate a label identification code. As a non-limiting example, a hash function may be used to generate a label identification code. In some embodiments, the label identification code can be repeated multiple times, substantially unique, or globally unique. An example hash function for use in this application takes an input of any length (the physical property data) and produces as output a fixed length string (the label identification code). The label identification code can be generated based on some or all of the physical property data for a particular label.

In other embodiments, it may be sufficient if there are a relatively small number of available identifiers. In those embodiments, accessing a label identifier could then retrieve the product identifiers associated with the label identifiers. In particular, this embodiment may be applicable if the label scanning device is of lower resolution.

In some embodiments, the label identification code can be generated as a digital signature using a signature module. The signature module can receive the physical property data, an authorization key, a security token or any combination of them. In some embodiments, the signature module may receive, in addition, one or more intrinsic machine, product, or product item characteristics, or any combination of those characteristics alone or in combination. The signature module can create a digital signature based on any or all of those inputs.

To generate the digital signature, in some embodiments, the signature module can first generate a digest or other representation of the physical property data. In some embodiments, the digest can be generated by calculating a cryptographic hash value of the configuration data according to a digital signature algorithm provided by the signature module executing the digital signature algorithm. As non-limiting examples, the hash may be calculated according to any message digest or hash function, such as MD5 (Message-Digest algorithm 5), SHA-1 (Secure Hash Algorithm 1), SHA-2 (Secure Hash Algorithm 2), SHA-3 (Secure Hash Algorithm 3) or Keccak hash or message digest functions. Optionally, the digest can then be encrypted using a private key obtained by the signature module to generate the digital signature.

### Production Code Generation

A production code can be generated for an item that is produced. The production code can subsequently be associated with the item. The production code for an item can be based on any arbitrary data associated with the item being produced. As a non-limiting example, the production code could be based on configuration data relating to the production environment or processes for the item, or a combination of the production environment and processes for the item. Supplied production configuration data can indicate any or all of the parameters including, but not limited to, machine for production, production line, factory, product to be produced, and volume of product. The configuration data may indicate what items (for example, products) are to be marked with the identifiers and how those items may be produced. The configuration data may indicate a range of products, such as starting and ending product identifiers. In some embodiments, the range can be a set of product identifiers. The identifiers can include, or be based on, the date or time of production of a product to be marked, or a combination of the date and time.

The configuration data may be provided by an operator of the system or be dynamically or automatically generated. The configuration data can include further executable instructions or an interpretable algorithm. The configuration data may be based on operator input or the output of a manufacturing execution system, or other centralized system for instructing how and what to produce.

In some embodiments, the production code may be validated. One such embodiment includes electronically receiving configuration data from an electronic data store and electronically storing the configuration data for a production run, where the configuration data for the production run specifies parameters used in the production of products. The configuration data is transmitted to an authorization module. At the authorization module, the system is configured for determining whether the production run is authorized. If the production run is authorized, then the system generates validated configuration data comprising a key and a representation of a plurality of authorized item identifiers. In some further embodiments, the validated configuration data can be transmitted to a signature module where, at the signature module, the validated configuration data is signed.

### Item Identifier Generation

The production code may be used in connection with, or as an input to, a method for creating an item identifier. The processing apparatus may be configured to combine the stored measured physical property or feature with other information for any desired purpose including, for example, to generate a secure item identifier. Alternatively, the production code may be subsequently used on a product as the item identifier.

The production code and the stored measured physical property or feature can be virtually paired so as to be associated with each other. The pairing is recorded or is otherwise made retrievable. The pairing of the label identification code (as represented by the stored measured physical property or feature) and the production code can be performed at any time. For example, the pairing could be performed before the generation of the label identification code, at the same time, or after a production code is generated that relates to the product.

In one embodiment, the pairing sequence could be executed as follows: applying a label onto an item; measuring a physical property of the label; encoding the measured physical property to create a label identification code; generating a production code for the item; generating an item identifier, wherein the item identifier is based on the production code and the label identification code; pairing the item identifier and the label identification code; and printing the item identifier onto the item. This method pairing may allow a smaller data number as the item identifier is an aggregation or combination of the label identification code and the configuration data.

To generate an item identifier based on the production code and the label identification code, the label identification code can be applied as the key for an encryption algorithm applied to the production code. As a non-limiting example, the label identification code can be used as the key for a symmetric-key algorithm applied to the production code to derive an encrypted production code which may be applied to products. In alternative embodiments, the production code may be applied by XOR operation with the label identification code to derive a new item identification code for application to the product.

In another embodiment, the pairing sequence could be executed as follows: applying a label onto an item; generating a production code for the item; generating an item identifier, wherein the item identifier is based on the production code; printing the item identifier onto the item; measuring a physical property of the label; encoding the measured physical property to create a label identification code; scanning the printed item identifier on the item; and pairing the label identification code and the item identifier.

In other embodiments, the label issuing entity could scan the label at the time of label printing, generate a corresponding label identification code, and print the label identification code on the label. In such an embodiment, the scanning of the label features could be used as a random code generation. In these embodiments, it would not be necessary to determine the fiber structure, in particular, after handling.

Alternatively, the label issuing entity could generate a different or additional code and print that code on the label for easier reading. This alternative code could be a continuous code or an encrypted code. The authentication then is created with the pairing.

### Application of Item Identification

An identification code can be recorded (e.g., printed) on the item. As described above, the identification code could be, as non-limiting examples, the label identification code, a derived combination of the label identification code and the production code, or the result of the pairing of the codes.

### Item Authentication

As described herein, the system can be configured for electronically pairing the label identification code and the item identifier. In some embodiments, there is provided a method for authenticating a production of products, the method including pairing the item identification code and the item identifier; receiving either the item identification code or the item identifier; at an authentication module, verifying the label identification code by performing a query to retrieve an associated item identifier based on an input label identification code, or verifying the item identifier by performing a query to retrieve an associated label identification code based on an input item identifier. The input label identification code or item identifier can be independently secured and validated in connection with the query.

### Example Embodiments

According to one example embodiment for a method for generating a secure item identifier for an item, as illustrated in FIG. 2, the method comprises: applying a label onto an item (205); measuring a physical property of the label to create a label identification code (210); generating a production code for the item (215) and generating an item identifier, wherein the item identifier is based on the production code and the label identification code (220); electronically pairing the physical property with the production code (225); and printing the item identifier onto the item (230).

According to one example embodiment for a method for generating a secure item identifier for an item, as illustrated in FIG. 3, the method comprises: applying a label onto an item (305); generating a production code for the item (310); generating an item identifier, wherein the item identifier is based on the production code and printing the item identifier onto the item (315); measuring a physical property of the label (320); encoding the measured physical property to create a label identification code (325); scanning the printed item identifier on the item (330); and electronically pairing the label identification code and the item identifier (335).

According to one example embodiment for generating a code for securely identifying products produced at a production facility, the method comprises: electronically receiving configuration data from an electronic data store;

electronically storing the configuration data for a production run, wherein the configuration data for the production run specifies parameters used in the production of products; transmitting the configuration data to an authorization module; at the authorization module: determining whether the production run is authorized; generating validated configuration data comprising a key, a representation of a plurality of authorized product identifiers, and a security token; transmitting the validated configuration data to a signature module; at the signature module, signing the validated configuration data; at an identification module, receiving a request for a product identifier and generating a product identifier in response to the request; transmitting the product identifier from the identification module to a signature module; digitally signing the product identifier at the signature module; and transmitting the digitally signed product identifier to a printer module; applying the digitally signed product identifier as a label onto an item; measuring a physical property of the label to create a label identification code; generating a production code for the item; generating an item identifier, wherein the item identifier is based on the production code and the label identification code; and electronically pairing the measured physical property or information based on the measured physical property with the production code or information based on the production code.

In an alternative or additional embodiment, the label identification code is created by encoding the measured physical property. In an alternative or additional embodiment, the measured physical property of the label is derived from a random physical structure of the label. In an alternative or additional embodiment, the random physical structure is a fiber structure of the label. In an alternative or additional embodiment, the measured physical property of the label is derived from a color of the label. In an alternative or additional embodiment, the measured physical property of the label is a covert feature not visible to a naked eye. In an alternative or additional embodiment, the measured physical property of the label is of a specified area less than all of the label. In an alternative or additional embodiment, the measured physical property of the label is substantially the entire area of the label. In an alternative or additional embodiment, the production code is generated based on configuration data relating to a production environment for the item. In an alternative or additional embodiment, the method comprises verifying a received label identification code by performing a query to retrieve an associated item identifier based on the received label identification code. In an alternative or additional embodiment, the method comprises verifying a received item identifier by performing a query to retrieve an associated label identification code based on the received item identifier.

### Further Applications

For audit purposes, the pairing may be shared with a label issuing entity. Additionally, the systems and methods described herein can be used in combination with orchestration, ranging, error correction, decryption features and modules.

### Integration with Secure Production Systems

The systems and methods described above for generating a secure identification code can be used in combination with integrated systems for generating secure identifiers for use with a production.

As used herein, an entity may refer to: i) a person, such as a consumer of a product; ii) a group, such as a group having a common interest, such as retailers; iii) a computing device; iv) a computing node in a networked system; v) a storage location, such as a memory storage unit storing a document; vi) a virtual point in a network, such as representing a business function within a business enterprise, and the like. Additionally, an entity may represent a point in a workflow, such as for authorization, which may be performed by a person responsible for that aspect of the workflow or a computing device which provides automated processing. The term entity is not meant to be limited to any one of these examples and may extend to other situations consistent with the concepts described herein.

### Control Module

With reference to FIG. 4, the Control Module (also known as the “Orchestrator”) (410) can receive input from any of the other modules or outside sources and can provide instructions to the other modules in the system based on pre-configured programs and/or the operator inputs to it. It can also generate a dashboard summary of the system status.

Input to the Control Module can include any or all configuration data (405). The supplied configuration data can indicate any or all of the parameters including, but not limited to, machine for production, production line, factory, product to be produced, and volume of product. The configuration data may indicate what items (for example, products) are to be marked with the secure identifiers and how those items may be produced. The configuration data may indicate a range of products, such as starting and ending product identifiers. In some embodiments, the range can be a set of product identifiers. The configuration data may be provided by an operator of the system or be dynamically or automatically generated. The configuration data can include further executable instructions or an interpretable algorithm. The configuration data may be based on operator input or the output of a manufacturing execution system, or other centralized system for instructing how and what to produce.

The Control Module (410) can transmit the configuration data to any module, including but not limited to the Authorization Module (430), the Identification Module (440), and the Signature Module (445).

The Control Module can request authorization from the Authorization Module to execute a production operation. This process involves transmitting a request (including some or all of the configuration data) to the Authorization Module and receiving signed or encrypted configuration data. In some embodiments, the Authorization Module can return the configuration data to the Control Module, including a digital signature applied to that configuration data. The Authorization Module determines whether to authorize the request from the Control Module based on the data it receives. In addition, the information returned by the Authorization Module included in the Configuration data can be used to bound the codes generated with the authorization provided. As the data is signed by the Authorization Module, the system can be prevented from modifying the configuration data. As a non-limiting example, a modification of a request to produce one brand on in place of another may be controlled, allowed, or denied.

Authorizations received from the Authorization Module can also be transmitted to the Verification Module so that verification requests can be subsequently processed against those authorizations. The data transmitted to the Verification Module can include a secure identifier, as well as any of the configuration data. In some examples, the configuration data sent to the Authorization Module can include product range information.

The signed or validated configuration data can be the some or all of the set of input parameters of the Control Module, verified and validated by the Authorization Module, which remains in force during a production. A security token can be an output from the Authorization Module and/or an input parameter of the Control Module. The security token can be a proof that the product identifier corresponds to validated configuration data and therefore to an authorized production. The security token can be an input to the Signature Module to generate a signature for a single product identifier, or the signature of a single product identifier, or a product identifier itself, or a range of products or product identifiers. The security token can be a unique code, a random code, or a pseudo-random code. The security token can be any numerical, or alphabetic, or combination of numeric and alphabetic characters.

### Authorization Module

The Authorization Module operates to validate requests for authorization to take an action in the identification system. In some embodiments, it can operate as a license manager.

The Authorization Module can receive the configuration data. The Authorization Module can also receive range and/or algorithm information. In some embodiments, the Authorization Module can receive input configuration data from the Control Module. The output range can optionally identify a range of products, machines, factories, ranges, or product volumes that are authorized. The output can also include range information and/or include an algorithm which comprises a set of executable or interpretable instructions that will be used to generate the security token. The Authorization Module can be centralized at the factory level or be decentralized on each production line, or a combination of both.

The Authorization Module can store and/or generate one or more encryption keys. In some embodiments, the key stored by the Authorization Module can be a private public encryption key according to a public key infrastructure (PKI). In some embodiments, the Authorization Module stores the only copy of the private key. In other embodiments, the Authorization Module is distributed across several instances which replicate the keys between them. In the case of PKI, the Authorization Module can output signed configuration data. In some embodiments, the Authorization Module can encrypt the configuration data and/or sign the configuration data output.

In some embodiments, the system is configured so that only the Authorization Module can read the secured input parameters of the Control Module, required for the generation of the security token. In some embodiments, the key is provided to the Authorization Module from another source.

The Authorization Module can be embodied as a hardware security module (HSM), or another type of physical computing device that safeguards and manages digital keys for strong authentication and providing cryptoprocessing. The Authorization Module functionality can be performed by a computer with an embedded board with an encryption key or PKI private key. The module can be equipped with features such that attempts to access the data will result in it being rendered unreadable or inaccessible.

If the input to the Authorization Module is a range and an algorithm, the Authorization Module can output an identity in the range of authorization and a security token of the identifier. For example, the output identity can be a range from 0 to 1,000 with a security token for each item in the range.

The Authorization Module can generate a key from any parameter used in the Control Module. In some embodiments, the Authorization Module may generate or derive a key from an existing key from any parameter used in the Control Module such that only a specific Authorization Module can use this key. The equipment and software implementing this public key technique can be embodied in an asymmetric cryptosystem.

The output of the Authorization Module can be information, such as the configuration data and, optionally, one or more security tokens, with a digital signature provided by the Signature Module. Alternatively, the output of the Authorization Module can be the configuration data encrypted to a key held by the Authorization Module. The output of the Authorization Module can be provided to the Control Module.

According to an embodiment, the method for authenticating a production of products includes electronically storing configuration data for a production run, wherein the configuration data for the production run specifies parameters used in the production of products; determining if the configuration data for the production run is authorized; if the production run is authorized: generating a security token and associating the token with the configuration data; and digitally signing the configuration data by generating a digital signature and associating the digital signature with the configuration data; receiving the digitally signed configuration data and the digital signature at a production machine; at the production machine, verifying the digital signature associated with the digitally signed configuration data; calculating a set of secure product identifiers based on the digitally signed configuration data; producing products in a production run according to the digitally signed configuration data; and printing the set of secure product identifiers on the products according to the digitally signed configuration data.

In an alternative or additional embodiment, the configuration data represents a range of products to be produced. In an alternative or additional embodiment, the configuration data represents a range of products, machines, factories, ranges, or product volumes that are authorized. Alternative or additional embodiments can include receiving a verification request, the request comprising a product identifier and determining if the configuration data for the production run is authorized by reference to a license manager. Alternative or additional embodiments can include generating a security token for a range of products; and associating the security token with the range of products.

### Signature Module

With reference to FIGS. 4-6, the Signature Module can receive the configuration data, an authorization key, a security token or any combination of them, as well as a unique product identifier generated by the Identification Module. In some embodiments, the Signature Module may receive, in addition, one or more intrinsic machine and/or product characteristics, and/or product item characteristics. The Signature Module can create a digital signature based on any or all of those inputs, generally referred to herein as configuration data.

To generate the digital signature, in some embodiments, the Signature Module can first generate a digest or other representation of the configuration data. In some embodiments, the digest can be generated by calculating a cryptographic hash value of the configuration data according to a digital signature algorithm provided by the Signature Module executing the digital signature algorithm. As non-limiting examples, the hash may be calculated according to MD5, SHA-1, SHA-2, SHA-3/Keccak functions. The digest can then be encrypted using a private key obtained by the Signature Module to generate the digital signature.

In some embodiments, a digital signature may use a Public Key Infrastructure (PKI) technology to establish authenticity of configuration data. PKI systems use certificates and keys to identify entities, individuals, or organizations. The Authentication Module uses a private key to sign the configuration data and associates the configuration data with a certificate including the public key used by the Authentication Module.

A recipient module uses a public key to verify the digital signature and, thereby, the authenticity of the signed configuration data. Supporting technologies can be employed to establish other non-repudiation features, such as the time of signing and the status of the signing keys. The public key may be provided to the recipient entity directly, or by publication in an on-line repository or directory.

### Identification Module

The Identification Module can receive the configuration data and generate identifiers for items to be marked. The Identification Module can receive a digital signature generated by the Signature Module that will be combined with the unique identifier to generate a compound unique identifier.

The identifiers can include, or be based on, the date and/or time of production of a product to be marked and the digital signature received from the Signature Module. In some embodiments, the secure identifiers generated can be unique or substantially unique. In some embodiments, the secure identifiers can be the security token.

In the case of ranges, the Identification Module can generate a range identifier and a set of identifiers within the generated range.

The identifiers created may be output to a print control module for direct printing on to a product or may be input to further processing to generate another code that is printed on product packaging.

### Verification Module

With reference to FIG. 6, the Verification Module (450) can be configured to use the enhanced verification methods described above. The Verification Module can further be configured to receive the verified configuration data and, based on that validated configuration data, validate a request for authorization (605) for a factory, machine, product, or production volume reported. The inputs to the Verification Module can include any or all of the verified configuration data, output from the signature module, identifiers, security tokens, and/or range information. The Verification Module can generate information for an Authorization Module with these parameters in order to verify/validate a product identifier.

The Verification Module can generate a decryption (620) of the request, which includes one or more identifiers or ranges of identifiers (615) and signature data (610) including one or more security tokens.

If a security token is input to the Verification Module, the Verification Module can return information relating to the authorization, the configuration data, and/or ranges. If a single security token is used for a range of products, the security token can be provided to the Verification Module to verify parameters associated with the range of products, rather than individual products. This embodiment may be particularly useful in the context of export regulation.

### System Processes

### Identification Code Initialization

Identification Code Initialization can be performed to validate the authorization and the parameters, In some embodiments, for performance reasons, this can be performed once at the beginning of the production. With reference to FIG. 4, the Control Module (410) can access a data store (415) for additional parameters, or additional parameters can be provided to the module. The parameters and the configuration data, once signed by the Authorization Module (430), form the validated configuration data (435). The Control Module receives verified configuration data as described above, in response to its request to the Authorization Module (430).

The authorization can be an authorization to produce a product, or to mark a product with a certain ID, or both. The configuration data and the additional parameters are transmitted to the Authorization Module and are used by the Authorization Module to generate the security token. The Authorization Module can sign the configuration data and the additional parameters, forming the signed configuration data. As discussed above, the configuration data can specify a certain production run or other products and activities. The Authorization Module can generate an authorization block including a key, authorized identifiers, and security token. In some embodiments, the key may be generated by the Authorization Module, or may be provided to it. The Authorization Module can transmit the authorization block to the Control Module. The Control Module can transmit the validated configuration data and other information, such as a list of identifiers, a range of identifiers, and/or one or more security tokens, to the Signature Module (445). The Signature Module can sign the data and send the signed data and the signature to the Control Module. The Identification Module (440) can then receive from the Control Module an initialization block including the identifiers and/or ranges of identifiers for products.

An embodiment of the invention can include a method for initializing a process for securely controlling a production facility, comprising: electronically receiving configuration data from an electronic data store; electronically storing the configuration data for a production run, wherein the configuration data for the production run specifies parameters used in the production of products; transmitting the configuration data to an authorization module; at the authorization module: determining whether the production run is authorized; generating validated configuration data comprising a key, a representation of a plurality of authorized product identifiers, and a security token; transmitting the validated configuration data to a signature module; and at the signature module, signing the validated configuration data.

Alternative or additional embodiments can include determining if the configuration data for the production run is authorized; if the production run is authorized: generating a security token and associating the token with the configuration data; and digitally signing the configuration data by generating a digital signature and associating the digital signature with the configuration data.

Alternative or additional embodiments can include receiving the digitally signed configuration data and the digital signature at a production machine; at the production machine, verifying the digital signature associated with the digitally signed configuration data; and calculating a set of secure product identifiers based on the digitally signed configuration data.

Alternative or additional embodiments can include producing products in a production run according to the digitally signed configuration data; and printing the set of secure product identifiers on the products according to the digitally signed configuration data.

Alternative or additional embodiments can include determining whether the production run is authorized further comprises retrieving licensing data from a licensing server.

### Identification Code Generation

With reference to FIG. 5 the Code Generation process generates the codes during the production process. The identification code generation process can begin with a request to the Identification Module (440) for an identifier or a range of identifiers, which are then returned to the Control Module (410). The identifiers are then sent to the Signature Module (445), which signs the identifiers and returns the signed identifiers to the Control Module. The Signature Module can receive a security token. In some embodiments, the Signature Module does not need to be controlled by external instructions and if any identification code is to be counted, the code can be linked to a single security token. The Signature Module can be controlled by the Authorization Module. The Control Module can then send the output data to print control in Printer Module (510). The output data sent to the print control may be encrypted before transmission. The configuration data, can be transmitted to the Verification Module (450) for the handling of subsequent verification requests.

An embodiment of the invention includes a method for generating a code for securely identifying products produced at a production facility, including electronically receiving configuration data from an electronic data store; electronically storing the configuration data for a production run, wherein the configuration data for the production run specifies parameters used in the production of products; transmitting the configuration data to an authorization module; at the authorization module: determining whether the production run is authorized; generating validated configuration data comprising a key, a representation of a plurality of authorized product identifiers, and a security token; transmitting the validated configuration data to a signature module; at the signature module, signing the validated configuration data; at an identification module, receiving a request for a product identifier and generating a product identifier in response to the request; transmitting the product identifier from the identification module to a signature module; digitally signing the product identifier at the signature module; and transmitting the digitally signed product identifier to a printer module.

Alternative or additional embodiments can include electronically receiving configuration data from an electronic data store; electronically storing the configuration data for a production run, wherein the configuration data for the production run specifies parameters used in the production of products; transmitting the configuration data to an authorization module; at an authorization module: determining whether the production run is authorized; generating validated configuration data comprising a key, a representation of a plurality of authorized product identifiers, and a security token; transmitting the validated configuration data to a signature module; at the signature module, signing the validated configuration data.

In alternative or additional embodiments, the request is for a range of identifiers. Alternative or additional embodiments can include determining if the configuration data for the production run is authorized; if the production run is authorized: generating a security token and associating the token with the configuration data; and digitally signing the configuration data by generating a digital signature and associating the digital signature with the configuration data.

### Verification of Identification Code

As described above, the Verification Module (considered here in the singular as the serial or parallel relationships of multiple logical or physical Verification Modules) can receive a request for verification. The request can include one or more identification codes. The verification module can decrypt or otherwise deobfuscate the identifier code received. The resulting information, having been decrypted, can include a signature component and an identifier. The resulting identifier can then be linked against the original configuration data previously stored in association with the identifier. The linked data can include other identifiers in a range, a security token, and other information stored in connection with the production of the product bearing that identification code.

Some embodiments can include additional functionality for processing identifiers that are provided to the Verification Module based on the party requesting the verification of the code. Different parties can be provided with different means to access the Verification Module. For example, a retailer or other form of merchant, may be provided with a different portal or communication channel than a consumer. The retailer may also be required to authenticate itself to the Verification Module.

In some embodiments, the system can be configured so that a verification by a consumer results in an identifier being marked as having been verified. The system can be further configured to store those codes for which verification is requested by a consumer. Any subsequent requests for verification of those already-verified codes can be denied or otherwise processed differentially.

### Export Functions

Embodiments of the invention can be applied in the context of code export to third-parties. Those embodiments can include an export function configured to generate a separate code for this purpose. The exported code can be generated by collecting one or more product identifiers and/or security tokens, and signing those identifiers and/or tokens. The identifiers and/or tokens can be collected at any point in the production process. The signed identifiers and/or tokens in the form of exported codes can be provided to a third party who can store them and perform verification of the validity of the identifiers and/or tokens.

### System Architectures

The methods may be performed by components arranged as either on-premise hardware, on premise virtual systems, or hosted-private instances. Some or all of these embodiments and methods may be considered to be “hosted” or in the “cloud”. Additionally, various aspects of the methods described herein may be combined or merged into other functions. Example computerized systems for implementing the invention are illustrated.

A processor or computer system can be configured to particularly perform some or all of the method described herein. In some embodiments, the method can be partially or fully automated by one or more computers or processors. The invention may be implemented using a combination of any of hardware, firmware, software, or a combination thereof. The present invention (or any part(s) or function(s) thereof) may be implemented using hardware, software, firmware, or a combination thereof and may be implemented in one or more computer systems or other processing systems. In some embodiments, the illustrated system elements could be combined into a single hardware device or separated into multiple hardware devices. If multiple hardware devices are used, the hardware devices could be physically located proximate to or remotely from each other. The embodiments of the methods described and illustrated are intended to be illustrative and not to be limiting. For example, some or all of the steps of the methods can be combined, rearranged, or omitted in different embodiments.

In one exemplary embodiment, the invention may be directed toward one or more computer systems capable of carrying out the functionality described herein. Example computing devices may be, but are not limited to, a personal computer (PC) system running any operating system such as, but not limited to, Microsoft™ Windows™. However, the invention may not be limited to these platforms. Instead, the invention may be implemented on any appropriate computer system running any appropriate operating system. Other components of the invention, such as, but not limited to, a computing device, a communications device, mobile phone, a telephony device, a telephone, a personal digital assistant (PDA), a personal computer (PC), a handheld PC, an interactive television (iTV), a digital video recorder (DVD), client workstations, thin clients, thick clients, proxy servers, network communication servers, remote access devices, client computers, server computers, routers, web servers, data, media, audio, video, telephony or streaming technology servers, etc., may also be implemented using a computing device. Services may be provided on demand using, e.g., but not limited to, an interactive television (iTV), a video on demand system (VOD), and via a digital video recorder (DVR), or other on demand viewing system.

The system may include one or more processors. The processor(s) may be connected to a communication infrastructure, such as but not limited to, a communications bus, cross-over bar, or network, etc. The processes and processors need not be located at the same physical locations. In other words, processes can be executed at one or more geographically distant processors, over for example, a local-area network (LAN) or wide-area network (WAN) connection. Computing devices may include a display interface that may forward graphics, text, and other data from the communication infrastructure for display on a display unit.

The computer system may also include, but is not limited to, a main memory, random access memory (RAM), and a secondary memory, etc. The secondary memory may include, for example, a hard disk drive or a removable storage drive, such as a compact disk drive (CD-ROM), etc. The removable storage drive may read from and write to a removable storage unit. As may be appreciated, the removable storage unit may include a computer usable storage medium having stored therein computer software and data. In some embodiments, a machine-accessible medium may refer to any storage device used for storing data accessible by a computer. Examples of a machine-accessible medium may include, e.g., but not limited to: a magnetic hard disk; a floppy disk; an optical disk, like a compact disk read-only memory (CD-ROM) or a digital versatile disk (DVD); a magnetic tape; and a memory chip, etc.

The processor may also include, or be operatively coupled to communicate with, one or more data storage devices for storing data. Such data storage devices can include, as non-limiting examples, magnetic disks (including internal hard disks and removable disks), magneto-optical disks, optical disks, read-only memory, random access memory, and flash storage. Storage devices suitable for tangibly embodying computer program instructions and data can also include all forms of non-volatile memory, including, for example, semiconductor memory devices, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

The processing system can be in communication with a computerized data storage system. The data storage system can include a non-relational or relational data store, such as a MySQL™ or other relational database. Other physical and logical database types could be used. The data store may be a database server, such as Microsoft SQL Server™, Oracle™, IBM DB2™, SQLITE™, or any other database software, relational or otherwise. The data store may store the information identifying syntactical tags and any information required to operate on syntactical tags. In some embodiments, the processing system may use object-oriented programming and may store data in objects. In these embodiments, the processing system may use an object-relational mapper (ORM) to store the data objects in a relational database. The systems and methods described herein can be implemented using any number of physical data models. In one example embodiment, a relational database management system (RDBMS) can be used. In those embodiments, tables in the RDBMS can include columns that represent coordinates. In the case of economic systems, data representing companies, products, etc. can be stored in tables in the RDBMS. The tables can have pre-defined relationships between them. The tables can also have adjuncts associated with the coordinates.

In alternative exemplary embodiments, secondary memory may include other similar devices for allowing computer programs or other instructions to be loaded into computer system. Such devices may include, for example, a removable storage unit and an interface. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units and interfaces, which may allow software and data to be transferred from the removable storage unit to computer system.

The computing device may also include an input device such as but not limited to, a mouse or other pointing device such as a digitizer, and a keyboard or other data entry device (not shown). The computing device may also include output devices, such as but not limited to, a display, and a display interface. Computer may include input/output (I/O) devices such as but not limited to a communications interface, cable and communications path, etc. These devices may include, but are not limited to, a network interface card, and modems. Communications interface may allow software and data to be transferred between computer system and external devices.

In one or more embodiments, the present embodiments are practiced in the environment of a computer network or networks. The network can include a private network, or a public network (for example the Internet, as described below), or a combination of both. The network includes hardware, software, or a combination of both.

From a telecommunications-oriented view, the network can be described as a set of hardware nodes interconnected by a communications facility, with one or more processes (hardware, software, or a combination thereof) functioning at each such node. The processes can inter-communicate and exchange information with one another via communication pathways between them using interprocess communication pathways. On these pathways, appropriate communications protocols are used.

An exemplary computer or telecommunications network environment in accordance with the present embodiments may include nodes, which may include hardware, software, or a combination of hardware and software. The nodes may be interconnected via a communications network. Each node may include one or more processes, executable by processors incorporated into the nodes. A single process may be run by multiple processors, or multiple processes may be run by a single processor, for example. Additionally, each of the nodes may provide an interface point between network and the outside world, and may incorporate a collection of sub-networks.

In an exemplary embodiment, the processes may communicate with one another through interprocess communication pathways supporting communication through any communications protocol. The pathways may function in sequence or in parallel, continuously or intermittently. The pathways can use any of the communications standards, protocols or technologies, described herein with respect to a communications network, in addition to standard parallel instruction sets used by many computers.

The nodes may include any entities capable of performing processing functions. Examples of such nodes that can be used with the embodiments include computers (such as personal computers, workstations, servers, or mainframes), handheld wireless devices and wireline devices (such as personal digital assistants (PDAs), modem cell phones with processing capability, wireless email devices including BlackBerry™ devices), document processing devices (such as scanners, printers, facsimile machines, or multifunction document machines), or complex entities (such as local-area networks or wide area networks) to which are connected a collection of processors, as described. For example, in the context of the present invention, a node itself can be a wide-area network (WAN), a local-area network (LAN), a private network (such as a Virtual Private Network (VPN)), or collection of networks.

Communications between the nodes may be made possible by a communications network. A node may be connected either continuously or intermittently with communications network. As an example, in the context of the present invention, a communications network can be a digital communications infrastructure providing adequate bandwidth and information security.

The communications network can include wireline communications capability, wireless communications capability, or a combination of both, at any frequencies, using any type of standard, protocol or technology. In addition, in the present embodiments, the communications network can be a private network (for example, a VPN) or a public network (for example, the Internet).

A non-inclusive list of exemplary wireless protocols and technologies used by a communications network may include BlueTooth™, general packet radio service (GPRS), cellular digital packet data (CDPD), mobile solutions platform (MSP), multimedia messaging (MMS), wireless application protocol (WAP), code division multiple access (CDMA), short message service (SMS), wireless markup language (WML), handheld device markup language (HDML), binary runtime environment for wireless (BREW), radio access network (RAN), and packet switched core networks (PS-CN). Also included are various generation wireless technologies. An exemplary non-inclusive list of primarily wireline protocols and technologies used by a communications network includes asynchronous transfer mode (ATM), enhanced interior gateway routing protocol (EIGRP), frame relay (FR), high-level data link control (HDLC), Internet control message protocol (ICMP), interior gateway routing protocol (IGRP), internetwork packet exchange (IPX), ISDN, point-to-point protocol (PPP), transmission control protocol/internet protocol (TCP/IP), routing information protocol (RIP) and user datagram protocol (UDP). As skilled persons will recognize, any other known or anticipated wireless or wireline protocols and technologies can be used.

Embodiments of the present invention may include apparatuses for performing the operations herein. An apparatus may be specially constructed for the desired purposes, or it may comprise a general purpose device selectively activated or reconfigured by a program stored in the device.

In one or more embodiments, the present embodiments are embodied in machine-executable instructions. The instructions can be used to cause a processing device, for example a general-purpose or special-purpose processor, which is programmed with the instructions, to perform the steps of the present invention. Alternatively, the steps of the present invention can be performed by specific hardware components that contain hardwired logic for performing the steps, or by any combination of programmed computer components and custom hardware components. For example, the present invention can be provided as a computer program product, as outlined above. In this environment, the embodiments can include a machine-readable medium having instructions stored on it. The instructions can be used to program any processor or processors (or other electronic devices) to perform a process or method according to the present exemplary embodiments. In addition, the present invention can also be downloaded and stored on a computer program product. Here, the program can be transferred from a remote computer (e.g., a server) to a requesting computer (e.g., a client) by way of data signals embodied in a carrier wave or other propagation medium via a communication link (e.g., a modem or network connection) and ultimately such signals may be stored on the computer systems for subsequent execution).

The methods can be implemented in a computer program product accessible from a computer-usable or computer-readable storage medium that provides program code for use by or in connection with a computer or any instruction execution system. A computer-usable or computer-readable storage medium can be any apparatus that can contain or store the program for use by or in connection with the computer or instruction execution system, apparatus, or device.

A data processing system suitable for storing or executing the corresponding program code can include at least one processor coupled directly or indirectly to computerized data storage devices such as memory elements. Input/output (I/O) devices (including but not limited to keyboards, displays, pointing devices, etc.) can be coupled to the system. Network adapters may also be coupled to the system to enable the data processing system to become coupled to other data processing systems or remote printers or storage devices through intervening private or public networks. To provide for interaction with a user, the features can be implemented on a computer with a display device, such as an LCD (liquid crystal display), or another type of monitor for displaying information to the user, and a keyboard and an input device, such as a mouse or trackball by which the user can provide input to the computer.

A computer program can be a set of instructions that can be used, directly or indirectly, in a computer. The systems and methods described herein can be implemented using programming languages such as Flash™, JAVA™, C++, C, C#, Python, Visual Basic™, JavaScript™ M PHP, XML, HTML, etc., or a combination of programming languages, including compiled or interpreted languages, and can be deployed in any form, including as a stand-alone program or as a module, component, subroutine, or other unit suitable for use in a computing environment. The software can include, but is not limited to, firmware, resident software, microcode, etc. Protocols such as SOAP/HTTP may be used in implementing interfaces between programming modules. The components and functionality described herein may be implemented on any desktop operating system executing in a virtualized or non-virtualized environment, using any programming language suitable for software development, including, but not limited to, different versions of Microsoft Windows™, Apple™ Mac™, iOS™, Unix™/X-Windows™, Linux™, etc. The system could be implemented using a web application framework, such as Ruby on Rails.

Suitable processors for the execution of a program of instructions include, but are not limited to, general and special purpose microprocessors, and the sole processor or one of multiple processors or cores, of any kind of computer. A processor may receive and store instructions and data from a computerized data storage device such as a read-only memory, a random access memory, both, or any combination of the data storage devices described herein. A processor may include any processing circuitry or control circuitry operative to control the operations and performance of an electronic device.

The systems, modules, and methods described herein can be implemented using any combination of software or hardware elements. The systems, modules, and methods described herein can be implemented using one or more virtual machines operating alone or in combination with one other. Any applicable virtualization solution can be used for encapsulating a physical computing machine platform into a virtual machine that is executed under the control of virtualization software running on a hardware computing platform or host. The virtual machine can have both virtual system hardware and guest operating system software.

The systems and methods described herein can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks that form the Internet.

One or more embodiments of the invention may be practiced with other computer system configurations, including hand-held devices, microprocessor systems, microprocessor-based or programmable consumer electronics, minicomputers, mainframe computers, etc. The invention may also be practiced in distributed computing environments where tasks are performed by remote processing devices that are linked through a network.

The terms “computer program medium” and “computer readable medium” may be used to generally refer to media such as but not limited to removable storage drive, a hard disk installed in hard disk drive. These computer program products may provide software to computer system. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the description and claims, the terms “coupled” and “connected,” along with their derivatives, may be used. It should be understood that these terms may be not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm may be here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, it may be appreciated that throughout the specification terms such as “processing,” “computing,” “calculating,” “determining,” or the like, refer to the action or processes of a computer or computing system, or similar electronic computing device, that manipulate or transform data represented as physical, such as electronic, quantities within the computing system's registers or memories into other data similarly represented as physical quantities within the computing system's memories, registers or other such information storage, transmission or display devices.

In a similar manner, the term “processor” may refer to any device or portion of a device that processes electronic data from registers or memory to transform that electronic data into other electronic data that may be stored in registers or memory. A “computing platform” may comprise one or more processors. As used herein, “software” processes may include, for example, software or hardware entities that perform work over time, such as tasks, threads, and intelligent agents. Also, each process may refer to multiple processes, for carrying out instructions in sequence or in parallel, continuously or intermittently.

While one or more embodiments of the invention have been described, various alterations, additions, permutations and equivalents thereof are included within the scope of the invention.

In the description of embodiments, reference is made to the accompanying drawings that form a part hereof, which show by way of illustration specific in embodiments of the claimed subject matter. It is to be understood that other embodiments may be used and that changes or alterations, such as structural changes, may be made. Such embodiments, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other embodiments using alternative orderings of the computations could be readily implemented. In addition to being reordered, the computations could also be decomposed into sub-computations with the same results.

1. A method for generating a secure item identifier for an item, the method comprising:
applying a label onto an item;
measuring a physical property of the label to create a label identification code;
generating a production code for the item;
generating an item identifier, wherein the item identifier is based on the production code and the label identification code;
electronically pairing the measured physical property or information based on the measured physical property with the production code or information based on the production code; and
printing the item identifier onto the item.

2. The method according to claim 1, wherein the label identification code is created by encoding the measured physical property.

3. The method according to claim 1, wherein the measured physical property of the label is derived from a random physical structure of the label.

4. The method according to claim 1, wherein the random physical structure is a fiber structure of the label.

5. The method according to claim 1, wherein the measured physical property of the label is derived from a color of the label.

6. The method according to claim 1, wherein the measured physical property of the label is a covert feature not visible to a naked eye.

7. The method according to claim 1, wherein the measured physical property of the label is of a specified area less than all of the label.

8. The method according to claim 1, wherein the measured physical property of the label is substantially the entire area of the label.

9. The method according to claim 1, wherein the production code is generated based on configuration data relating to a production environment for the item.

10. The method according to claim 1, further comprising verifying a received label identification code by performing a query to retrieve an associated item identifier based on the received label identification code.

11. The method according to claim 1, further comprising verifying a received item identifier by performing a query to retrieve an associated label identification code based on the received item identifier.

12. A method for generating a code for securely identifying products produced at a production facility, comprising:
electronically receiving configuration data from an electronic data store;
electronically storing the configuration data for a production run, wherein the configuration data for the production run specifies parameters used in the production of products;
transmitting the configuration data to an authorization module;
at the authorization module:
determining whether the production run is authorized;
generating validated configuration data comprising a key, a representation of a plurality of authorized product identifiers, and a security token;
transmitting the validated configuration data to a signature module;
at the signature module, signing the validated configuration data;
at an identification module, receiving a request for a product identifier and generating a product identifier in response to the request;
transmitting the product identifier from the identification module to a signature module;
digitally signing the product identifier at the signature module;
transmitting the digitally signed product identifier to a printer module;
applying the digitally signed product identifier as a label onto an item;
measuring a physical property of the label to create a label identification code;
generating a production code for the item;
generating an item identifier, wherein the item identifier is based on the production code and the label identification code; and
electronically pairing the measured physical property or information based on the measured physical property with the production code or information based on the production code.

13. The method according to claim 12, wherein the label identification code is created by encoding the measured physical property.

14. The method according to claim 12, wherein the measured physical property of the label is derived from a random physical structure of the label.

15. The method according to claim 12, wherein the random physical structure is a fiber structure of the label.

16. The method according to claim 12, wherein the measured physical property of the label is derived from a color of the label.

17. The method according to claim 12, wherein the measured physical property of the label is a covert feature not visible to a naked eye.

18. The method according to claim 12, wherein the measured physical property of the label is of a specified area less than all of the label.

19. The method according to claim 12, wherein the measured physical property of the label is substantially the entire area of the label.

20. The method according to claim 12, wherein the production code is generated based on configuration data relating to a production environment for the item.

21. The method according to claim 12, further comprising verifying a received label identification code by performing a query to retrieve an associated item identifier based on the received label identification code.

22. The method according to claim 12, further comprising verifying a received item identifier by performing a query to retrieve an associated label identification code based on the received item identifier.
